(19) United States
(12) Patent Application Publication
(10) Pub. No.: US 2001/0017024 A1
(43) Pub. Date: Aug. 30, 2001

(54) MILL CUTTING MACHINE AND METHOD

(76) Inventors: ROBERT R. KRUK JR., CRESTWOOD, IL (US); BRUCE T. MACAULEY, NEWPORT BEACH, CA (US)

Correspondence Address: OLSON & HIERL, 20 NORTH WACKER DRIVE, SUITE 3600, CHICAGO, IL, 60606, US

(21) Appl. No.: 09/298,143

(22) Filed: Apr. 23, 1999

(51) Int. Cl. B67B 7/00

(52) U.S. Cl. 53/492

(57) ABSTRACT

A method and apparatus are provided for exposing the contents of a plurality of envelopes for extraction. An opening device is included for opening the plurality of envelopes on at least one edge by removing a predetermined portion thereof and forming opened envelopes. An extraction device is further included in operable communication with the opening device for receiving the opened envelopes and exposing the contents thereof for extraction for subsequent document processing. A control device is further included operably connected to both the opening and extraction devices, so that when the contents are extracted from an opened envelope, a next envelope is opened by the opening device.

### TECHNICAL FIELD OF THE INVENTION

This invention relates to a method and apparatus for opening the contents of envelopes for extraction, and particularly to opening mixed sized envelopes and exposing the mixed and varying sized documents contained therein for subsequent document processing.

### BACKGROUND OF THE INVENTION

The amount of mail received by businesses and federal, state and local government agencies continues to grow daily. For example, the large volumes of remittance mailings received by utility companies, department stores and other retail enterprises, banks and other lending institutions, insurance companies, credit card companies, etc., just to name a few, demonstrate the need for efficient handling of large volumes of incoming mail. Moreover, the U.S. Post Office indicates that daily volumes of such mailings will continue to increase appreciably in the near future. The use of an automated envelope opening machines is an essential component of any efficient office procedure for handling such large bulk volumes of remittance mailings.

The contents of each envelope are generally referred to as a transaction, and may consist of one or more documents including one or more invoices and/or one or more checks. The most common transaction consists of a single invoice stub (remit) and an accompanying payment check.

According to conventional methods of automated or semi-automated remittance processing, the contents, such as an invoice and an accompanying check, are processed by opening the envelope, extracting the contents from the envelope, placing the contents in the proper sequence and orientation, and then processing the contents. The opening, extraction, sequencing and orienting of the invoices and checks has been effected manually, and more recently, by the use of automated or semi-automated equipment.

However, envelopes are generally not the same size. Even in circumstances where customers are provided with standardized return envelopes, customers may frequently choose to respond via odd-sized envelopes. Furthermore, other materials, such as promotions, commercial announcements, coupons, and return correspondence can vary greatly in size and shape, and thus affect the transactional throughput.

“White mail”, also known in the remittance processing and document processing industry as “exception mail”, is a challenge unique thereto. This mail is represented by mixed sized envelopes and/or mixed and varying contents, such as, for example, full page, triple folded documents and/or folded checks. The prior art opening machines fail to accommodate such white mail in an efficient, non-damaging manner.

Specifically, the problem of opening an edge of a white mail envelope, without damaging the contents, has not been satisfactorily solved. Typically, such white mail must be manipulated, either by vibrating machines or by hand, to force the contents away from the edge to be cut. Another solution is to use an opener that must be handfed by the operator, again affecting throughput time and efficiency.

Numerous attempts have been made to automate the envelope opening process. Such automated prior art envelope opening machines have generally fallen into two categories. The first category is the multi-station machine which opens envelopes and presents them to multiple stations at which the operators sit to sort the opened envelopes. The second category consists of smaller, more compact machines which utilize a single operational setup.

Generally, such machines open the envelopes on one or two sides and then intermittently move the envelopes to an extraction station in a stroking manner. At the extraction station, vacuum fingers using suction cups are employed to engage the panels of the envelopes so that the contents may be extracted by the operator.

The vacuum fingers engage the panels of the envelopes and pull them apart. As the panels are pulled apart, the fingers pause during which time the operator is able to extract the contents. The vacuum cups then release the panels, whereupon the envelope is conveyed to a disposal station.

One major drawback of these vacuum-stroke machines is the limited amount of time available for extraction, which can affect transactional integrity. The extraction time on such machines is limited to the cycle time that the vacuum fingers engage and pull apart the envelope panels. The operator is limited to that amount of time to extract the contents. Furthermore, the vacuum can bleed through the envelope panels and hold the contents in place, making extraction difficult.

One solution has been to employ opener/extractors that open the envelopes on two or more sides, and expose the contents by moving the envelope panels away from the contents. One such opener/extractor is disclosed in commonly assigned U.S. Pat. No. 4,893,454 which is incorporated herein by reference. That opener/extractor folds the panels away from the contents, exposing the contents for easy extraction. Folding the panels away from the contents eliminates the problem of leaving a portion of the contents behind due to suction created by the vacuum fingers. This ensures transactional integrity by allowing the operator to extract all the contents for document processing.

While the disclosed opener/extractor solves most of the above-discussed problems, it employs slicing wheels that slice or trim off a portion of the envelope, forming chips. If the slicing wheels slice a large portion of the envelopes, making wide cuts, the chips thus formed are large and can clog the apparatus. Moreover, during such wide cuts, the slicing wheels can encounter paper clips or staples which can damage the wheels and the documents. If the cut is too small, the envelopes may not be completely cut. Finally, the slicing wheels leave sharp edges on the envelopes which can injure the operators.

In accordance with the present invention, an apparatus and method are provided for removing a predetermined portion of the envelopes forming opened envelopes and exposing the contents thereof for extraction. The contents may then be reordered and reoriented if necessary for subsequent document processing, so that the association among the contents of each envelopes is maintained.

### SUMMARY OF THE INVENTION

The present invention provides a new and useful apparatus and method for processing, i.e., opening and exposing, the contents of a plurality of envelopes for easy and complete extraction. The system embodying the present invention is especially suitable for processing “white mail”.

The present invention comprises a milling device, and an extraction device in operable communication with the milling device. In one embodiment, a control device, including control logic, is operably connected to at least the milling device and the extraction device, controlling the operation thereof. The present invention is an apparatus that opens the plurality of envelopes on at least one side, but preferably two or more sides, by removing or milling a predetermined portion of the envelope along the at least one, but preferably two or more, sides, thereby exposing the contents thereof for extraction. After the contents of one envelope are extracted, a next envelope, if one exists, may be opened. The apparatus maintains transactional integrity by ensuring that all the contents are exposed for extraction without being damaged, left behind or otherwise affected by the milling device.

Numerous other advantages and features of the present invention will become readily apparent from the following detailed description of the invention, from the claims, and the accompanying drawings.

### BRIEF DESCRIPTION OF THE DRAWINGS

In the accompanying drawings, that form a part of this specification, and in which like numerals are employed to designate like parts:

FIG. 1 is a perspective view of one embodiment of the apparatus in accordance with the present invention;

FIG. 2 is a top view of the envelope supply hopper of the opening device of FIG. 1 in accordance with the present invention;

FIG. 3 is an identical top view of FIG. 2 showing envelopes in position at the envelope retaining gates prior to envelope edge milling;

FIG. 4 is a top view of the envelope transport system of the opening device in accordance with the present invention;

FIG. 5 is an end view of the drop rollers utilized to transport the envelope to the envelope extraction/opening device taken along the line 5-5 of FIG. 4;

FIG. 6 is an end view partially in section of the envelope transport as utilized within the opening device taken along the line 6-6 of FIG. 4;

FIG. 7 is a cross-sectional view of a typical envelope retaining gate of the present invention;

FIG. 8 is an end schematic view of a portion of the opening device of the present invention illustrating different sizes of envelopes;

FIG. 9 is a top oblique view of the envelope extraction device of the present invention;

FIG. 10 is a top oblique view of the drive mechanism which operates the extraction device of the present invention;

FIG. 11 is an end view partially in section through the envelope extraction device of the present invention showing the apparatus at rest prior to commencement of the opening/extraction cycle;

FIG. 12 is an end view partially in section through the extraction device of the present invention at its 90° point in its cycle at which the envelope folder blades and grasping members are in engagement with the envelope panels prior to opening;

FIG. 13 is an end view partially in section through the extraction device of the present invention at its 270° point in its cycle of operation, illustrating the envelope panels being pulled into taut relationship with the envelope folder blades providing the envelope crease;

FIG. 14 is an end view partially in section through the extraction device of the present invention illustrating the extraction device having returned to its 360° or 0° rest position and illustrating the envelope with deflected and creased side panels following the envelope extraction operation;

FIG. 15 is an oblique view of the envelope track of the extraction device of the present invention into which envelopes pass following their extraction operation and illustrating an opened envelope and its contents exposed therein; and

FIG. 16 is an enlarged view partially in section of one embodiment of a mill cutting blade and envelope in accordance with the present invention.

### DETAILED DESCRIPTION OF THE INVENTION

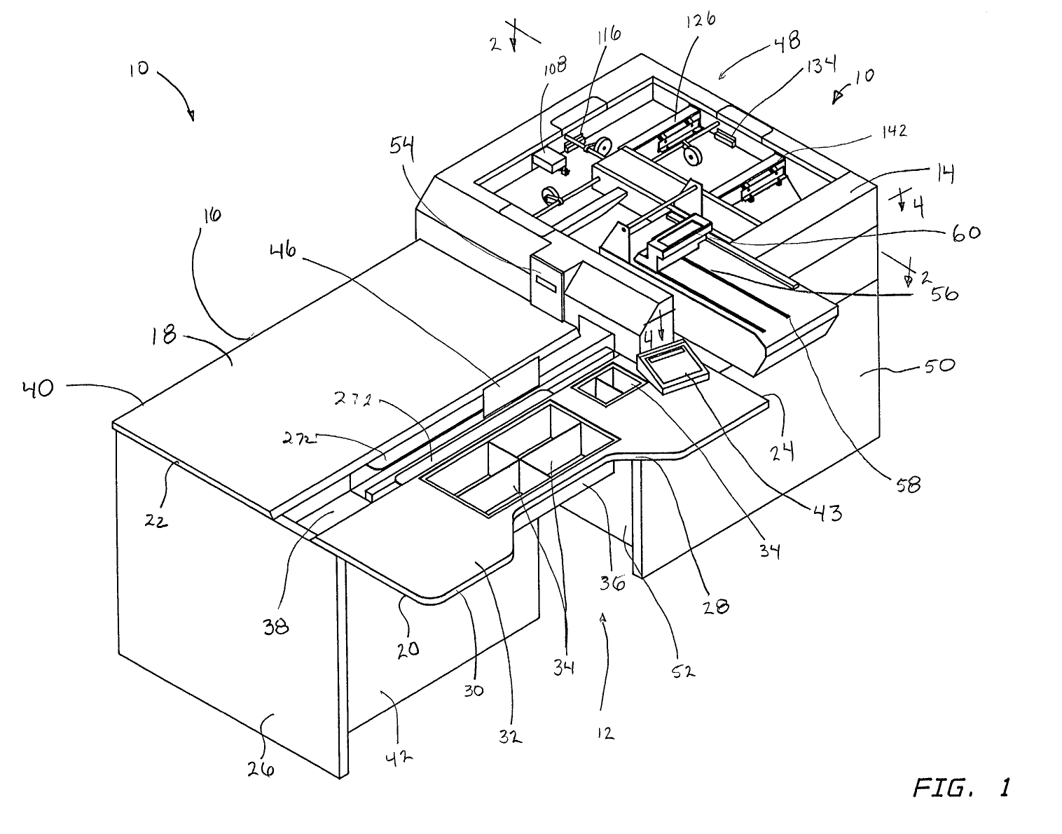

Referring to FIG. 1, a perspective view of a machine or apparatus for processing, including opening and extracting, the contents of a plurality of envelopes, generally designated 10, in accordance with the present invention is shown. In the embodiment depicted in FIG. 1, apparatus 10 includes a workstation 12, an opening device 14, and a control device 16, including control logic, located in workstation 12 in FIG. 1, although other placements are contemplated.

Workstation 12 depicted in FIG. 1 includes top and bottom surfaces 18 and 20 respectively, formed with side edges 22 and 24, and includes at least one support member 26, which extends between the bottom surface 20 and the ground. While one support member 26 is depicted, two or more are contemplated. Furthermore, it is contemplated that support member 26 may be fixed to bottom surface 20 by screws, pins, glue or the like. However, it is also contemplated that bottom surface 20 may rest on the support member 26 in an unfixed manner.

Top surface 18 is shown with a first cutout 28 defined in front edge 30, forming at least one work surface 32 with associated sorting trays 34. Work surface 32 defines at least one workstation, providing an operator with space to prepare documents prior to scanning and/or sorting. It is contemplated that the workstation could include a drawer of keyboard tray 36 for storing needed articles or a keyboard. A second cutout or track trough 38 is defined below top surface 18 in proximity to the first cutout 28, extending from side edge 22 to side edge 24, where track trough 38 accommodates an associated envelope track, discussed in greater detail below.

Additional cutouts are contemplated. Workstation 12 could include a third cutout (not shown) formed in proximity to back edge 38 to accommodate a snorkel support for a computer monitor shelf supporting a monitor. Additionally, a fourth cutout (not shown) is contemplated to accommodate a CPU, image acquisition device, keyboard or printer.

The above-described layout provides an ergonomic environment for the operator and provides easy access to the various components of apparatus 10, however other layouts are contemplated. Workstation 12 could be formed as two separate units, i.e. front and back shelves, each independently fixed to support member 26. Furthermore, instead of using cutouts, off-the-shelf items such an monitor supports and keyboard stands can be purchased to support monitors, keyboards, CPUs, image acquisition devices, etc.

In addition, it is contemplated that a storage cabinet (not shown) could be positioned proximate to the workstation 12 and/or an empty envelope receptacle 42 could be disposed beneath the workstation 12. The envelopes, following extraction of their contents, move from the right to the left in the envelope track and fall through an opening formed at the end of track trough 38 into the empty envelope receptacle.

Additionally, it is contemplated that means may be provided to allow the operator to access apparatus 10. In the embodiment depicted in FIG. 1, a data entry device 43 operably connected to control device 16, preferably by electrical connectors (not shown) is contemplated, allowing the operator to input codes, data, etc., in addition to accessing and logging onto apparatus 10. In one preferred embodiment, data entry device 43 is a keyboard that allows the operator to access the apparatus 10. However, other data entry devices are contemplated, including microphones, joysticks, mouses, light pens and the like.

Attention may now be paid to the control device 16, including control logic, operably connected to at least the opening device 14, and in one embodiment the extraction device 44, preferably by electrical connectors (not shown). Control device 16 could take many forms, but in one embodiment, it is comprised of at least one microprocessor (MP1) with control logic, preferably software, operable thereon, located in workstation 12 under top surface 18, which in turn operates and controls the apparatus 10.

Additionally, other embodiments are contemplated, such that control device 16 consists of two distinct microprocessors control devices (MP1 and MP2, not shown) including the control logic. In this embodiment, microprocessor control device MP1 is operably connected to at least the opening device 14 and microprocessor control device MP2 is operably connected to at least the extraction device 44.

As provided above, the control device 16 is operably connected to at least the opening device 14, preferably by electrical connections (not shown) and has the control logic operable thereon, which in one preferred embodiment is customized software. The contents 46 are extracted by the operator and prepared for subsequent processing by unfolding, ordering, orientating, and the like.

The contents 46 of an envelope are extracted by the operator and prepared for subsequent processing by unfolding, ordering, orientating, and the like. Removing the contents 46 from an envelope generates a signal which is received by the control device 16, which in turn instructs the opening device 14 to open a next envelope if available.

Removing the contents 46 from the envelope triggers a detector device. The detector device preferably sends a signal to the microprocessor control device MP1 of control device 16, which in turn sends a signal to the opening device 14. Opening device 14 is instructed to open a next envelope if available, wherein the contents 46 thereof may be prepared for processing.

The above cycle is repeated until all the envelopes are opened, and all the contents 46 thereof exposed and extracted. In one preferred embodiment, only the contents of one envelope are extracted at a time. In this embodiment, all the contents 46 of one envelope are extracted while the contents 46 of the next envelope are exposed, i.e., while the panels 46 of the next envelope are being deformed by the extraction device 44.

It is contemplated that the white mail to be processed may contain remit documents, payment stubs or invoices, checks, separate documents (referred to generally as other documents or full page documents), or some combination thereof. Generally, the full page documents are approximately 8½″ by 11″ in size and folded.

In one preferred embodiment, the envelope receiving device or track could include at least a pair of pressure rollers, or any other detection device suitable to monitor envelope thickness or the change in presence of contents. When the pressure rollers detect a change, i.e., that contents 46 have been removed from the envelope, then control device 16 issues commands to open the next envelope. In one embodiment, microprocessor control device MP1 issues such command.

The envelope receiving device or track could also include a plurality of photocells and associated light sources, or any other monitoring device, acting as a candling device in operable communication with microprocessor control device MP1 of control device 16. When the photocells detect a change in the envelope, microprocessor control device MP1 instructs that the next envelope be opened.

At least one photocell and associated light source (not shown) could be positioned on the envelope track in line with contents 46 which are exposed for extraction, so that the contents 46 interrupt the beam generated by the light source. After the operator removes the contents 46 from the envelope, the beam is reestablished. This generates a signal which is transmitted to the microprocessor control device MP1, which instructs the opening device 14 to open a next envelope.

Attention may now be turned to the opening device 14 of FIG. 1 for opening the envelopes on at least one edge, but preferably two or more edges, forming opened envelopes, and exposing the contents thereof for extraction. Many embodiments are contemplated for opening device 14 including a slitting device (not shown) well known in the art, that slits a predetermined portion of the envelopes on at least one edge forming opened envelopes; or an edge severing device, again well known in the art, that severs a predetermined portion of the envelopes on at least one edge forming said opened envelopes.

However, in one preferred embodiment, opening device 14 comprises a milling device 48, that mills a predetermined portion of the plurality of envelopes. Preferably, the milling device 48 mills or removes between about 0.001 inches to about 0.125 inches, but preferably between about 0.010 inches to about 0.015 inches, on at least one edge, but generally on two or more edges (on at least a leading edge and a longitudinal edge) forming opened envelopes.

FIG. 1 reveals a perspective view of the milling device 48 and the workstation 12. The milling device 48 has a housing 50 and is shown with at least one chip receptacle 52. The chip receptacle 52 is large enough to be positioned under three different mill cutting blades, as is explained hereinafter, to receive the chips or chads cut from the edges of the envelopes as they pass between the blades. The blades remove the predetermined portion of the at least one edge to form chads, which fall through an open chute leading directly into chip receptacle 52.

Housing 50 includes the various other apparatus such as a printing device 54, feed tray 56, the various envelope milling stations and associated gates to be described hereinafter, the envelope transport device, preferably in operable communication with at least the extraction device 44 and the opening device 14.

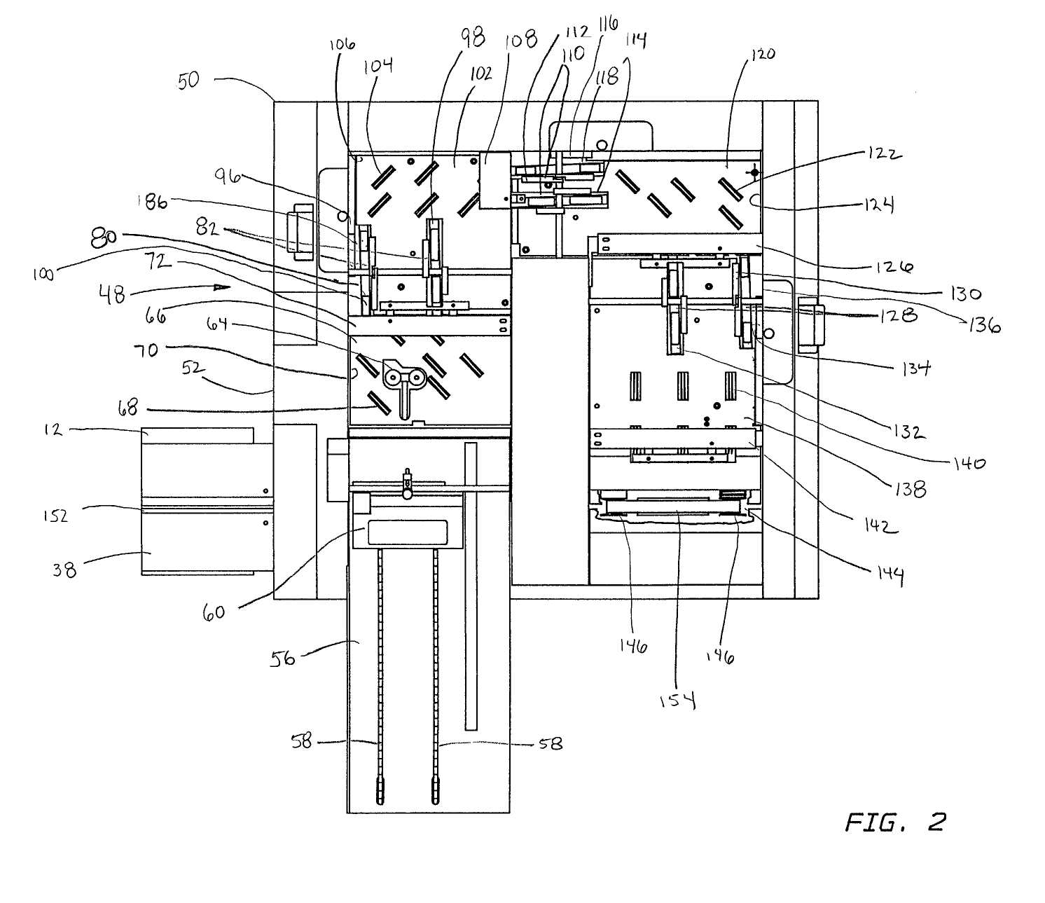

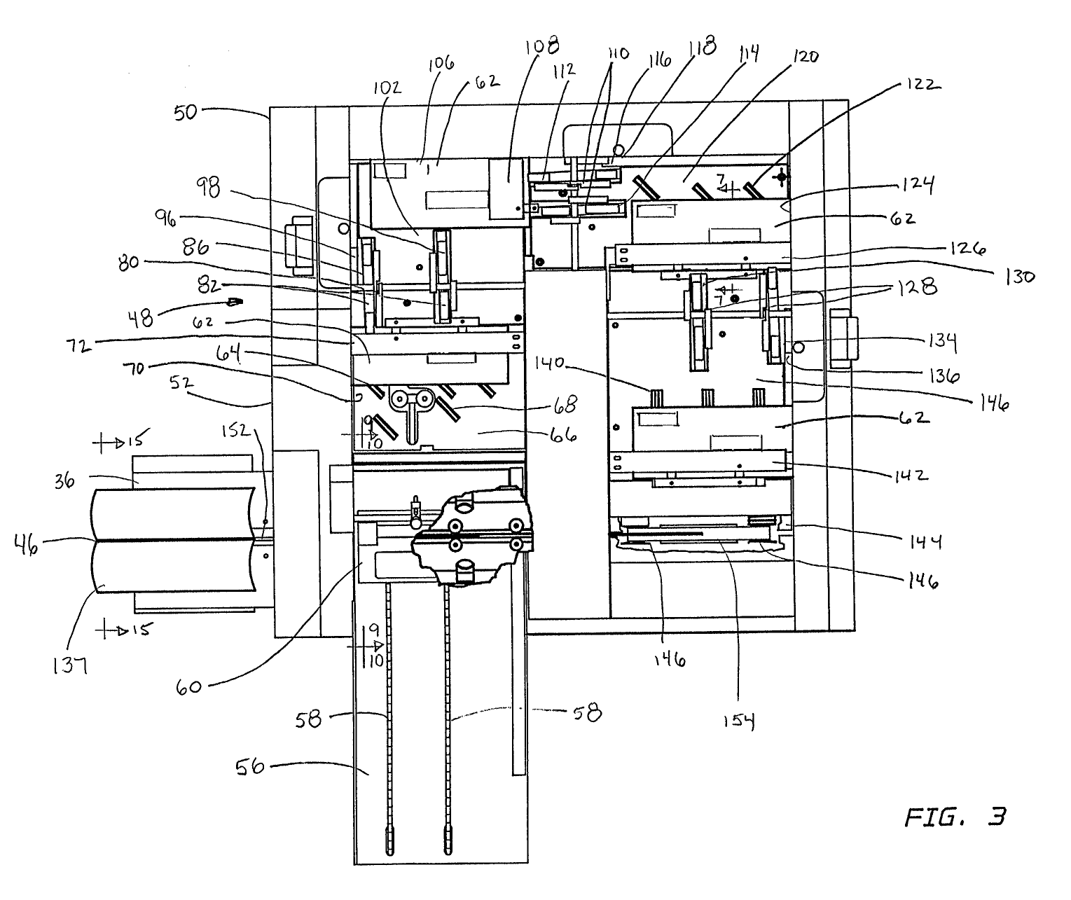

Referring now to FIGS. 2 and 3, there is illustrated a top plan view of the upper portion of the milling device 48. The feed tray 56 includes a set of conveyor chains 58 and associated follower block 60. This setup works in a manner such that, as envelopes are placed in front of the follower block 60, the conveyor chains 58 will operate until the stack of envelopes 62 reaches a photocell. When the envelopes 62 reach the photocell, further actuation of the conveyor chains 58 are stopped until sufficient envelopes 62 have been removed to again actuate the conveyor chains 58 to continuously move envelopes 62 into position for extraction from the tray.

Extraction of the envelopes 62 from the feed tray 56 is accomplished by means of a vacuum pickup 64. The vacuum pickup 64 rises up from beneath a wheelplate 66 to engage an envelope 62, and pull it downwardly upon the wheelplate 66. Wheelplate 66 includes a plurality of wheels 68 which are rotating and are positioned on an angle. The envelope 62 engages the wheels 68 and is pulled into alignment against the side rail 70 of the machine and against a first gate assembly 72. Such an arrangement is illustrated in FIG. 7 wherein the positioning of the envelopes 62 at the respective gates is illustrated.

A typical envelope gate assembly 72 is illustrated in FIG. 7. Gate assembly 72 includes a cover plate 74 which is secured to the wheelplate 66. Pivoted within the ends of the gate cover plate 74 is a gate arm 76 and its associated gate 78. FIG. 7 illustrates an envelope 62 riding upon the wheels 68 (shown in phantom) in abutment with the gate 78 during one phase of the envelope opening cycle (the gate 78 is shown in a raised position in phantom).

Returning now to FIG. 2, downstream of the first wheelplate 66 is a conveyor assembly 80 including two conveyors 82. These conveyors 82 are inclined at approximately a 3° angle towards the rail 70 and direct the envelope 62 into a first milling assembly 86.

The first milling assembly 86 includes at least one, but preferably two, rotating milling wheels or mill cutting blades 84 (best seen in FIG. 16). One of these mill cutting blades 84 is driven whereas the other is in overlapping relationship and is spring loaded. In operation, as the edge of the envelope 62 passes between the mill cutting blades 62, a small portion thereof, between about 0.001 inches to about 0.125 inches, but preferably between about 0.010 inches to about 0.015 inches is milled or trimmed off. This predetermined portion is preferred, in that it is large enough to completely open envelopes 62, yet small enough to avoid damaging the contents 46 or the mill cutting blades 84. It is noted that milling the edges does not leave a sharp edge formed by the prior art opening devices. Rather, the mill cutting blades 84 feather the edges of the envelopes 62 avoiding injury to the operator.

Turning now to FIG. 16, an enlarged view partially in section of one embodiment of a mill cutting blade 84 is provided. In this depicted embodiment, envelope 62 is aligned with a reference device 88, having an anvil 90 and a reference surface 92, so that only a predetermined portion of an edge thereof, between about 0.001 inches to about 0.125 inches, but preferably between about 0.010 inches to about 0.015 inches, is presented to the mill cutting blade 84.

FIG. 16 depicts the reference device 88 in a first vertical plane, while the mill cutting blade 84 is shown in a second vertical plane, defined at a predetermined angle to both the reference device 88 and reference surface 92. In one preferred embodiment, mill cutting blade 84 is perpendicular to both the reference device 88 and reference surface 92. Envelope 62, on the other hand, is shown in a horizontal plane perpendicular to both the first and second vertical planes of the reference device 88 and mill cutting blade 84, respectively. While this arrangement is preferred, other angles and relationships are contemplated, including the vertical plane of the mill cutting blade 84 and envelope 62 being set at some other predetermined angle to the vertical plane of the reference device 88, i.e., greater or less than 90 degrees with respect thereto. Such angles and relationships are manually selected and adjusted, in one embodiment the angle of blade 84 and/or reference device 88 is adjusted using a wrench, although other means are contemplated.

As shown, anvil 90 receives and supports the envelope 62, and presents envelope 62 to the reference surface 92 so that only a predetermined portion is presented to the mill cutting blade 84. That predetermined portion is then milled, forming chips or chads 94. These chads 94 are moved away from the envelope 62 by an airflow created by the movement of the mill cutting blade 84. Chads 94 are small enough to be easily moved while at the same time avoiding clogging the apparatus 10.

As illustrated in FIGS. 2, 3 and 16, chads 94 of the envelope 62 are free to fall into an open chute 96 which leads downwardly into the chip box or receptacle 52 as illustrated in FIG. 1. This open chute arrangement constitutes an advance in the art because in prior machines the chads 94 would often clog or jam the machine resulting in a shutdown.

A pair of pressure rollers 98 and 100 are shown in FIGS. 2 and 3 positioned over the conveyor 82. The pressure rollers 98, 100 press downwardly on the envelope 62 as it passes along the conveyor 82 to provide accurate and positive conveyance of the envelope 62 through the milling assembly 86.

As the envelopes 62 pass through the first milling assembly 86, they come upon a second wheelplate 102. The envelopes 62 first encounter a second set of rollers or wheels 104 which convey the envelopes 62, in a like manner, against a second rail 106 and against a second gate assembly 108. The second gate assembly 108 is substantially of the same design as the first gate assembly 72.

The first wheelplate 66, associated wheels 68, gate assembly 72 and first milling assembly 86 are designed to trim one small side (or leading edge) of the envelope 62.

Positioned downstream from the second gate assembly 108 is a like set of conveyors 110 positioned on a 3° angle. Positioned above them is a like set of pressure rollers 112 and 114. A second milling assembly 116 is positioned at the ends of the conveyors 110 and cooperates with an open chute 118 all in the same manner as that previously described for the first milling assembly 86. The second wheelplate 102 and its associated wheels, gate assembly 108, associated conveyors 110 and milling assembly 116 are designed to open the long edge (or longitudinal edge) of the envelope 62.

Positioned downstream from the second wheelplate 102 is a third wheelplate 120. The third wheelplate 120, as in the case of the other wheelplates, includes a set of inclined rollers or wheels 122 which are designed to bring the envelope 62 into engagement with the third rail 124 and against a third gate assembly 126, all as described above.

Positioned again downstream from the third gate assembly 126 is again a set of conveyors 128 and associated pressure rollers 130 and 132. These elements cooperate with a third milling assembly 134 and open chute 136 as heretofore described. This arrangement is designed to open the opposite short side (trailing edge) of the envelope 62 constituting the opening of the third side, forming panels 137.

Downstream from the third cutting assembly 126 is likewise a fourth wheelplate 138, associated conveyor wheels 140 which, in this case, direct the envelopes 62 in a straightforward direction to a fourth envelope gate 142.

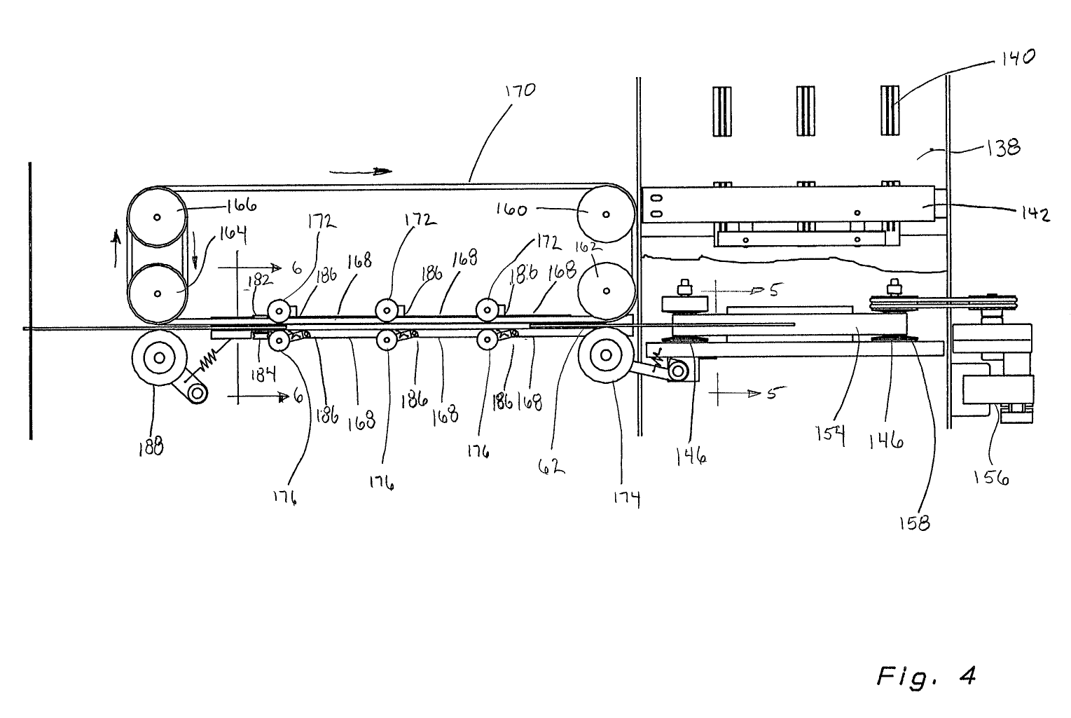

Downstream from the fourth gate 142 is a V-shaped vertical drop chute 144. Positioned beneath the vertical drop chute 144, and as best seen in FIGS. 4 and 5 of the drawings, is a plurality of drop rollers 146 which form a part of the overall envelope transport system to be hereinafter described.

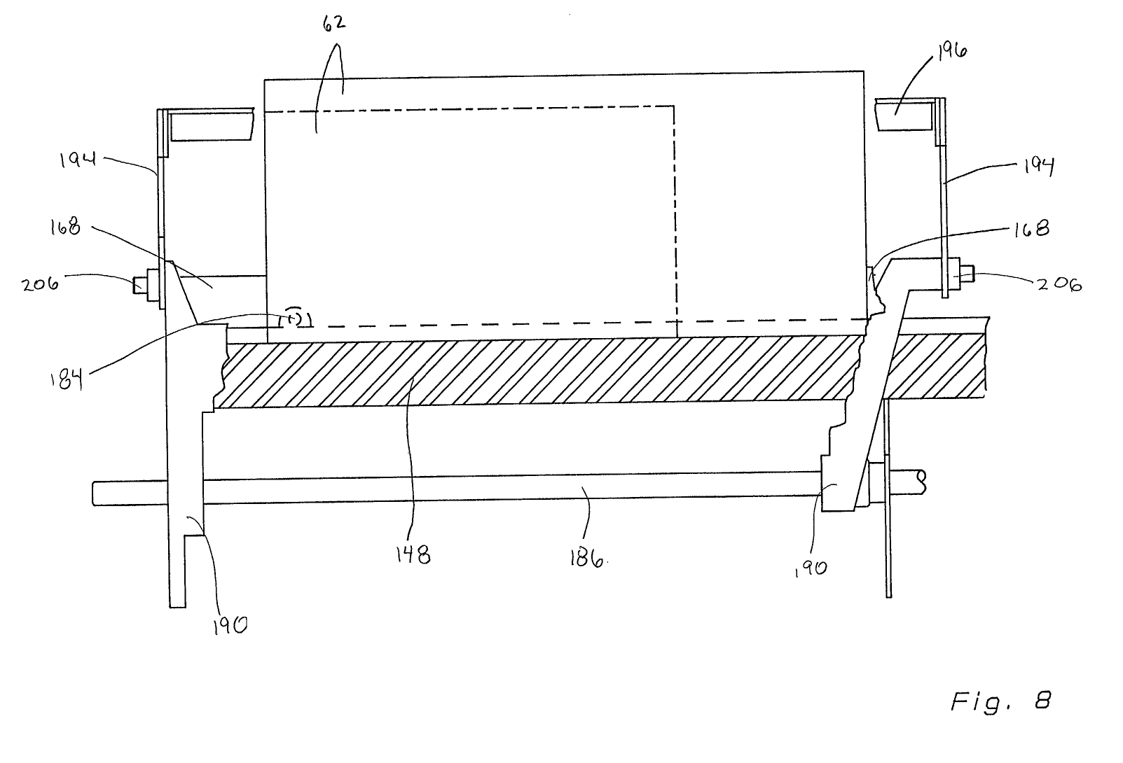

Referring now to FIGS. 4, 5 and 6, the envelope transport system is schematically shown. The envelope transport system works in conjunction with the envelope opening/extraction assembly likewise disclosed schematically in FIG. 8. The entire envelope transport system, as schematically illustrated in FIG. 4, includes a first series of drop rollers 146 which end at a folder track bar 148, whose function is described hereinafter. The drop rollers 146 are positioned in the bottom of the drop chute 144 as illustrated in FIG. 5 of the drawings.

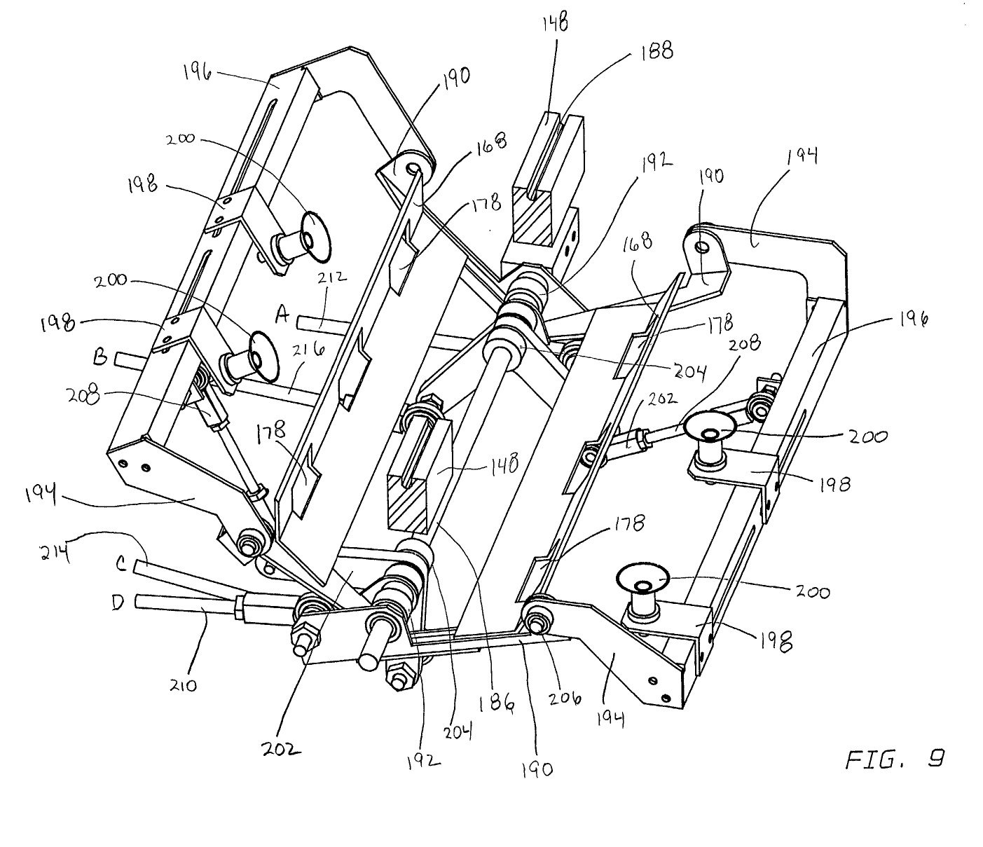

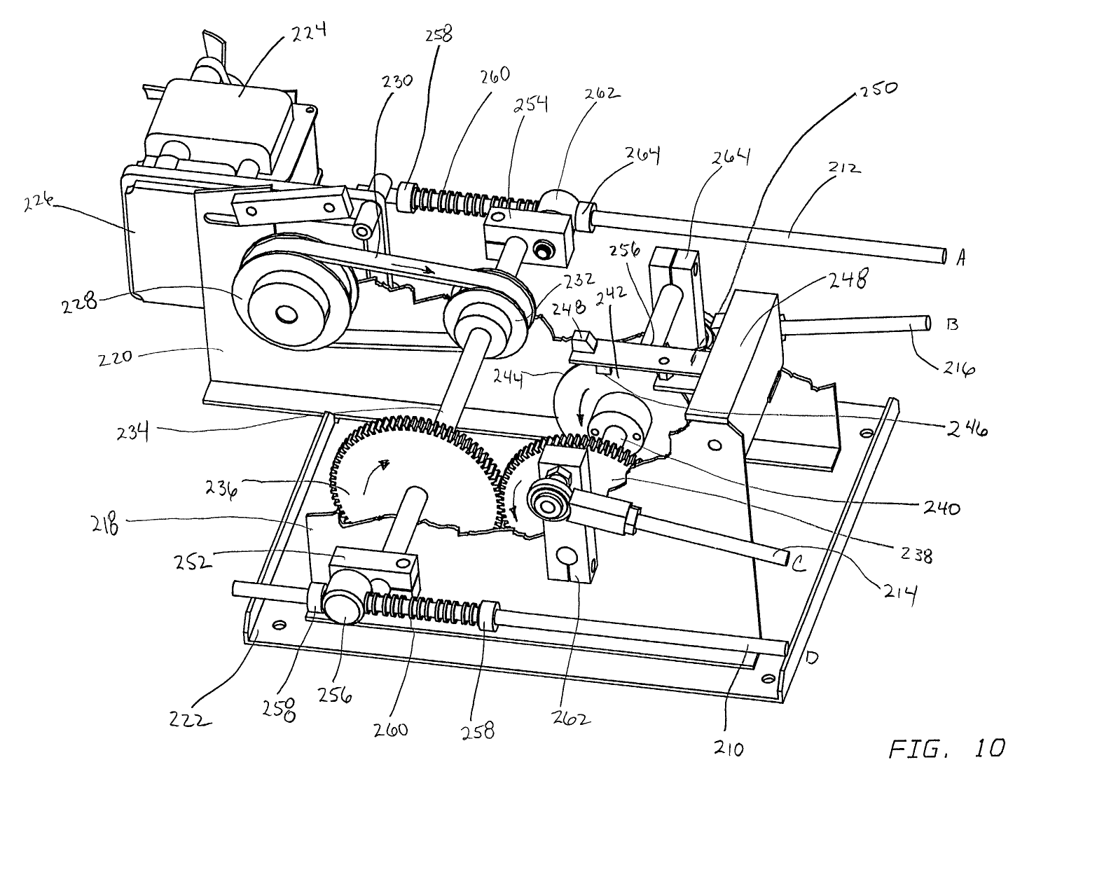

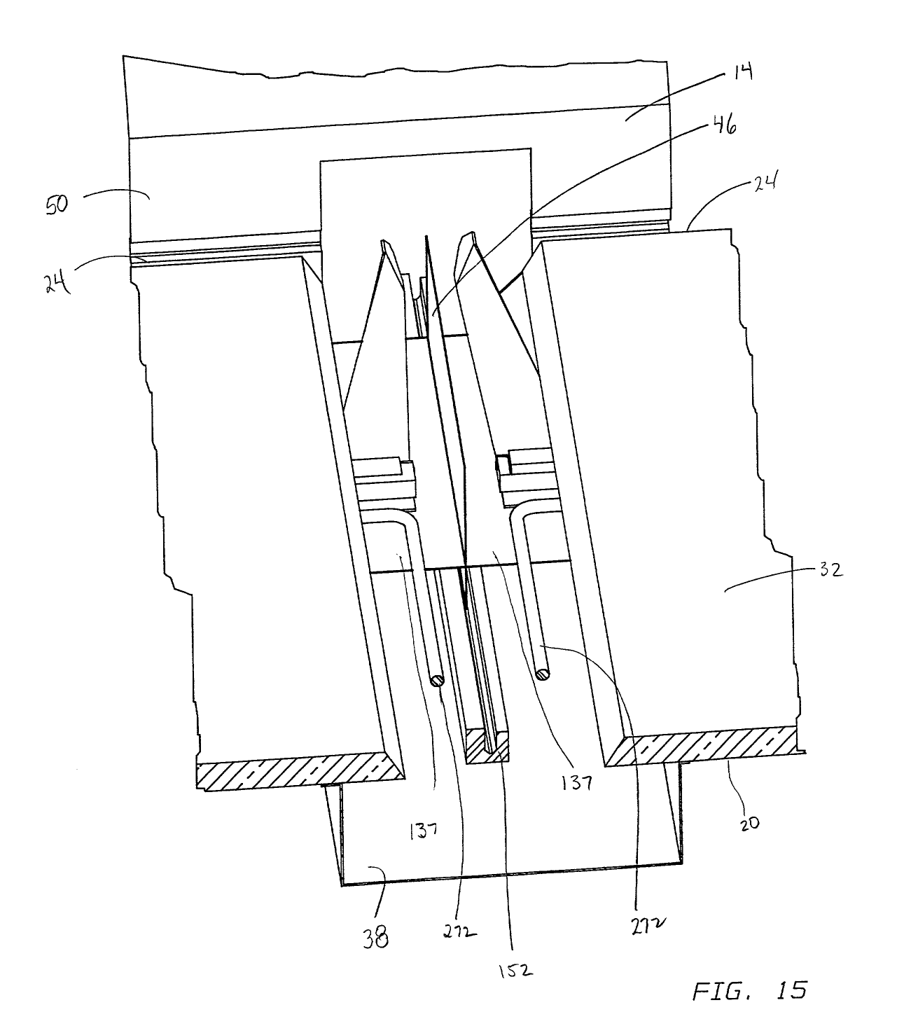

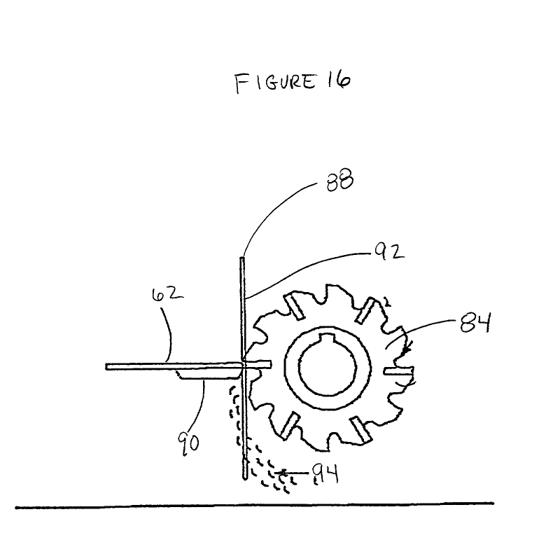

The track bar 148 and its associated assemblies comprising the remainder of the envelope transport system are positioned generally within the opening device 14 as schematically illustrated in FIG. 8 and as shown in FIG. 9. FIG. 9 only illustrates the folder track bar 148 with the remainder of the transport system being omitted for the purpose of clearly illustrating the operating mechanism of the opening assembly itself. The entire combined assembly of the envelope transport system associated with the folder track bar 148 and folder opening assembly, as illustrated schematically in FIG. 8 and as pictorially illustrated in FIG. 9, is positioned generally beneath the area of the follower block 60 and beneath the feed tray 56 as illustrated in FIGS. 2 and 3. The exit or left hand end of the folder track bar 148 interconnects with the track trough or second cut out 38 and its associated envelope track 152 again as shown in FIG. 1 of the drawings and as described in greater detail with reference to FIG. 15 hereinafter.

The operation of the transport system of the opening device 14 of the present invention is now described with reference to FIGS. 4, 5 and 6. It should be kept in mind that, as previously stated, the left hand portion of the transport system, as shown in FIG. 4, is operating in conjunction with and is interposed within or integrated within the opening mechanism as shown in FIGS. 8 and 9. This relationship of the envelope transport system as it is associated with the envelope opening/extraction device shown in FIG. 9 will become apparent from the following description of that portion of the transport system.

Referring again to FIGS. 4-6 of the drawings and particularly to the right hand portion thereof, the transport system includes two drop pulleys 146. Drop pulleys 146 are appropriately journaled beneath the V-shaped drop chute 144. Each drop pulley 146 includes a groove 158 therein and the pulleys are interconnected by friction flat belt 154 as shown in FIG. 4, with the first pulley 146 being interconnected to a drive motor 156. The drive motor 156 runs continuously, so that all the drop pulleys 146 are continuously running. The friction flat belt 154 is positioned within groove 158 of the drop pulleys 146 to provide friction for envelope 62 when envelope 62 falls through the drop chute 144 into engagement with the drop pulleys 146. In this manner, whenever an envelope 62 arrives at the drop chute 144, the envelope 62 is immediately moved forward toward the left hand portion of the transfer mechanism.

As an alternate embodiment to drop pulleys 146 and flat friction transfer belt 154 described above, it is contemplated that the transport system includes four drop rollers appropriately journaled beneath the V-shaped drop chute 144. Each drop roller includes V-grooves therein and the four rollers are interconnected by belts, with the first such roller being interconnected to drive motor 156. As the drive motor 156 runs continuously, all four drop rollers are continuously running. A high friction O-ring is positioned within the deep V-groove of each drop roller to provide friction for the envelope 62 when envelope 62 falls through the drop chute 144 into engagement with the drop rollers.

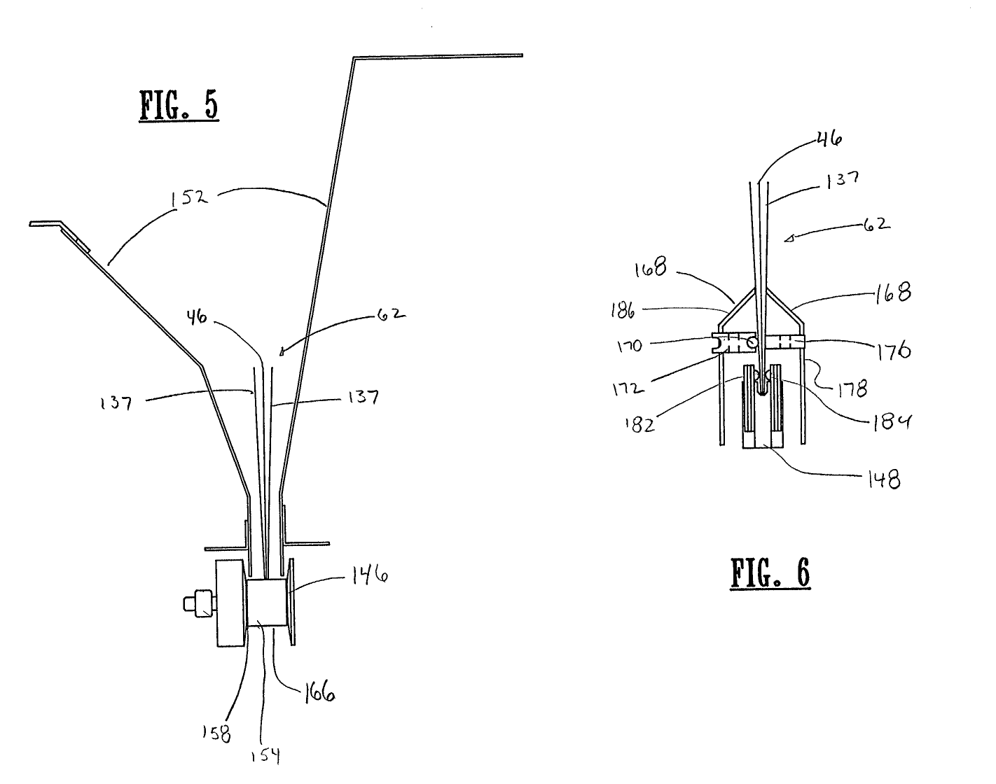

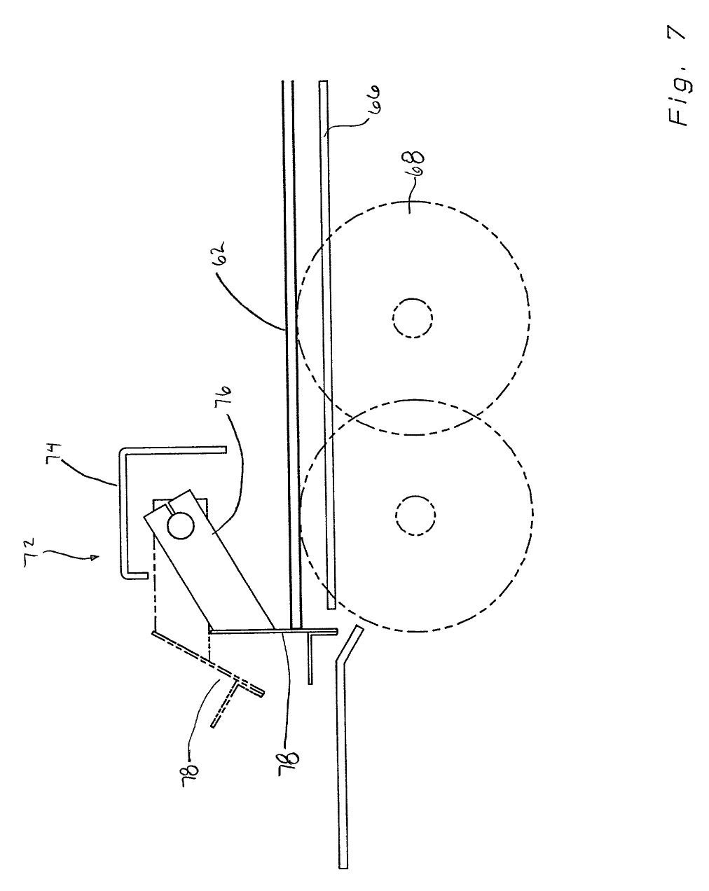

The transfer mechanism associated with the envelope opening mechanism includes four transfer belt pulleys 160, 162, 164 and 166 positioned outside either end of the opening mechanism shown in FIG. 8, i.e., beyond either end of opposed folder blades 168. A folder transfer belt 170 is designed to run generally in alignment with and above the folder track bar 148 as generally illustrated in FIG. 6 and to likewise run through the concavity formed by the closure of the two folder blades 168, likewise as illustrated in FIG. 6.

Three stationary guide wheels 172 are appropriately journaled within the loop formed by the folder belt 170 and generally above the folder track bar 148 as shown in FIG. 6. A groove within the guide wheels 172 provides a raceway for the folder transfer belt 170 and provides the driving interface between the transfer belt 170 and an envelope 62 positioned within the folder track bar 148, again as illustrated in FIG. 6.

Appropriate pressure is maintained upon the opposite side of the envelope 62 from the folder transfer belt 170 by means of a series of spring loaded pressure wheels. At the entrance end of the folder track bar 148, there is an entrance pressure wheel 174 that is positioned in opposing alignment with the idler transfer belt pulley 162. Following thereafter and in alignment with the guide wheels 172 are three small pressure wheels 176. The stationary guide wheels 172 and small pressure wheels 176 are journaled in alignment with apertures 178 in the folder blades 168. As described hereinafter, as the folder blades 168 actuate inwardly and outwardly, the apertures 178 provide clearance between the folder blades 168 and the stationary guide wheels 172 and small pressure wheels 176. Finally, at the exit end of the folder track bar 148 and in alignment with idler transfer belt pulley 162, there is a spring loaded exit pressure wheel 180. The combination of the idler wheels and stationary wheels working in conjunction with the pressure wheels provides adequate pressure between the envelope panel and the folder transfer belt 170 to move the envelope 62 through the transfer mechanism when the folder transfer belt 170 is in motion. The transfer belt 170 is driven by an appropriate belt and pulley arrangement to an appropriate motor through drive transfer belt pulley 166.

A photocell light 182 and associated photocell 184 are positioned just in advance of idler transfer belt pulley 162. The photocell 184 is interconnected through an appropriate electronic circuit arrangement working in conjunction with the drive motor (not shown) which operates the folder transfer belt 170 to detect the presence of an envelope 62 as it moves along in the folder track bar 148 and stops operation of the drive motor.

The drive motor may be any of a suitable type of motor to quickly and accurately stop the transfer belt 170. In one embodiment, a stepper motor is contemplated which uses a plurality of magnets to drive a motor shaft. Reversing the plurality of the magnets quickly and accurately stops the shaft. Alternately, a motor utilizing a quick reacting clutch and brake mechanism is also contemplated.

As illustrated in FIG. 8, the length of the opening mechanism is designed with regard to the positioning of the photocell 184 such that the opening mechanism can accept small envelopes 62 or large envelopes 62 indiscriminately and their leading edge will always be positioned at the same leading point within the opening mechanism.

The electronic control circuitry for the envelope opening device 14, which is in operable communication with, and controlled by, the control device 16, is such that, upon startup, the drive motor operating the folder transfer belt 170 will be actuated in the event that there is no envelope 62 present within the opening device 14 and as sensed by the photocell 184. At this point, the feed tray mechanism 74 will operate the conveyor chains 58 to move the supply of envelopes 62 forward until a photocell there senses their presence at the feed station. Each gate around the envelope milling assemblies includes a photocell as well as a photocell in the drop chute area 144 at the entrance end of the folder track bar 148.

The wheels associated with each wheelplate are continuously running as well as the conveyor belts and their associated mill cutting blades at each assembly. A gate assembly operates in a manner to restrain an envelope 62 at a particular gate from moving forward into the milling area until the gate is actuated, at which time the gate is raised. Raising the gate permits the envelope 62 to move underneath the pressure wheels associated with each transfer mechanism and through the miller assembly whereupon the envelope 62 then reaches the next set of continuously moving wheels and is transferred to the next gate assembly.

The control circuitry of the envelope opening device 14 is designed for a logic such that the absence of an envelope 62 in the drop chute area 144 or any gate will actuate the lifting of the immediately preceding gate to permit feeding of an envelope 62 to the drop chute area 144 or through the preceding cutting mechanism or, in the case of the first gate, feeding from the feed tray 56. In this way, the milling device 48 fills up entirely and there will always be an envelope 62 positioned at every gate awaiting for its sequential transfer through the milling device 48 ultimately to the extraction device 44. As provided above, the control circuitry of the opening device 14 is operably connected to control device 16, preferably by at least one electrical connection. The sequential transfer of the envelope 62 through the system, and onto the envelope track 152, is ultimately controlled by the control device 16 using the control logic as provided above.

At the envelope extraction device 44, an envelope 62, which has dropped into the drop chute 144, will immediately be brought up to the entrance end of the folder track bar 148. At this point, if the folder transfer belt 170 is not operating, the envelope 62 will simply come up against the folder transfer belt 170. The envelope 62 will remain there during the cycle of operation of extraction device 44 within which there will already be an envelope 62 sensed which will have caused the transfer belt 170 to have stopped. Following the extracting/opening cycle of the envelope 62, as to be described hereinafter, the folder transfer belt control circuitry is actuated, thus moving the folder transfer belt 170 and exiting the opened envelope 62 out the exit end of the folder transfer bar onto the envelope track 152 as previously described.

As the transfer belt 170 begins its movement, the next following envelope 62, already present at the entrance end of the transfer track bar 148, will thus move into the transfer assembly until the photocell 184 is reached, at which point the folder transfer belt 170 will be stopped. Thereafter, the logic circuitry in operable communication with the control device 16 and as regulated by the photocells at the entrance end of the folder track bar 148 and the respective gates will cycle the gates to move the next envelope 62 through the system.

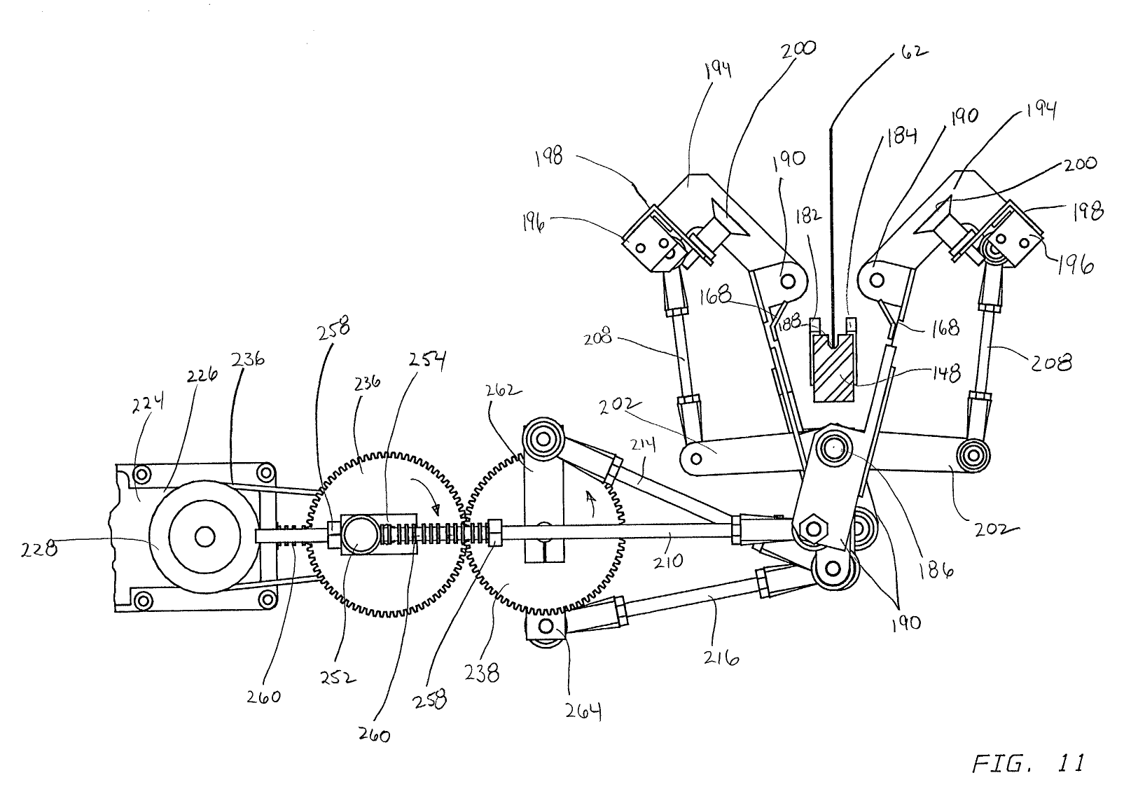

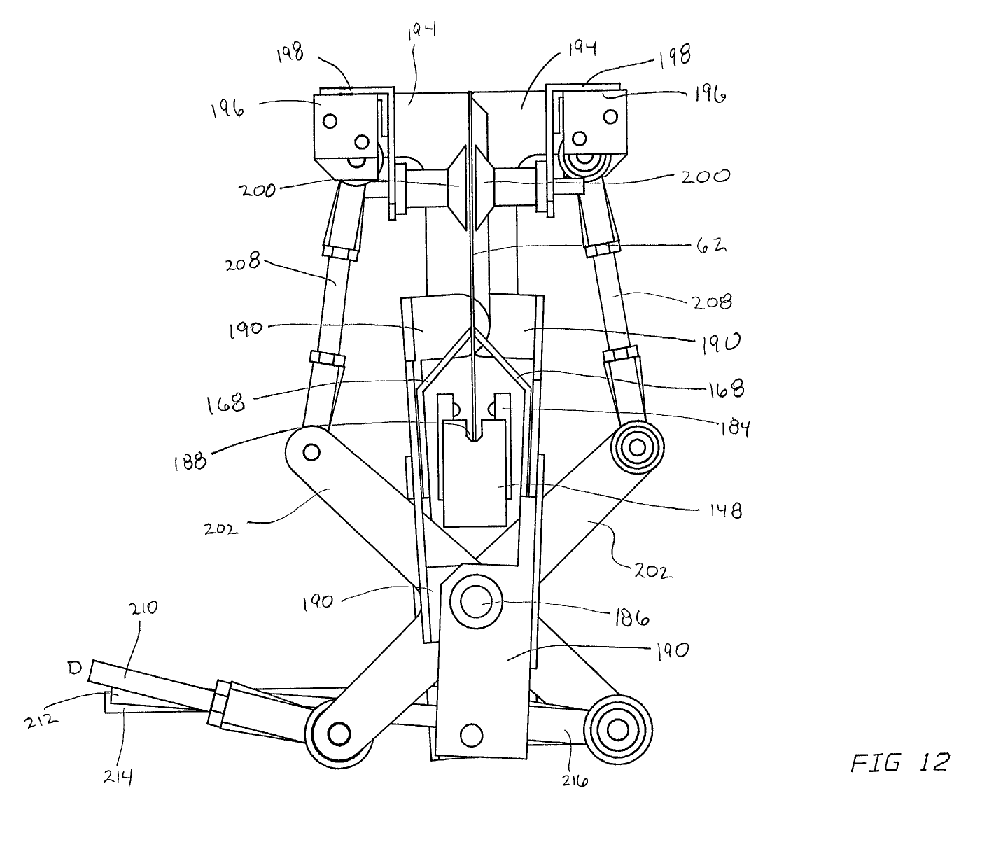

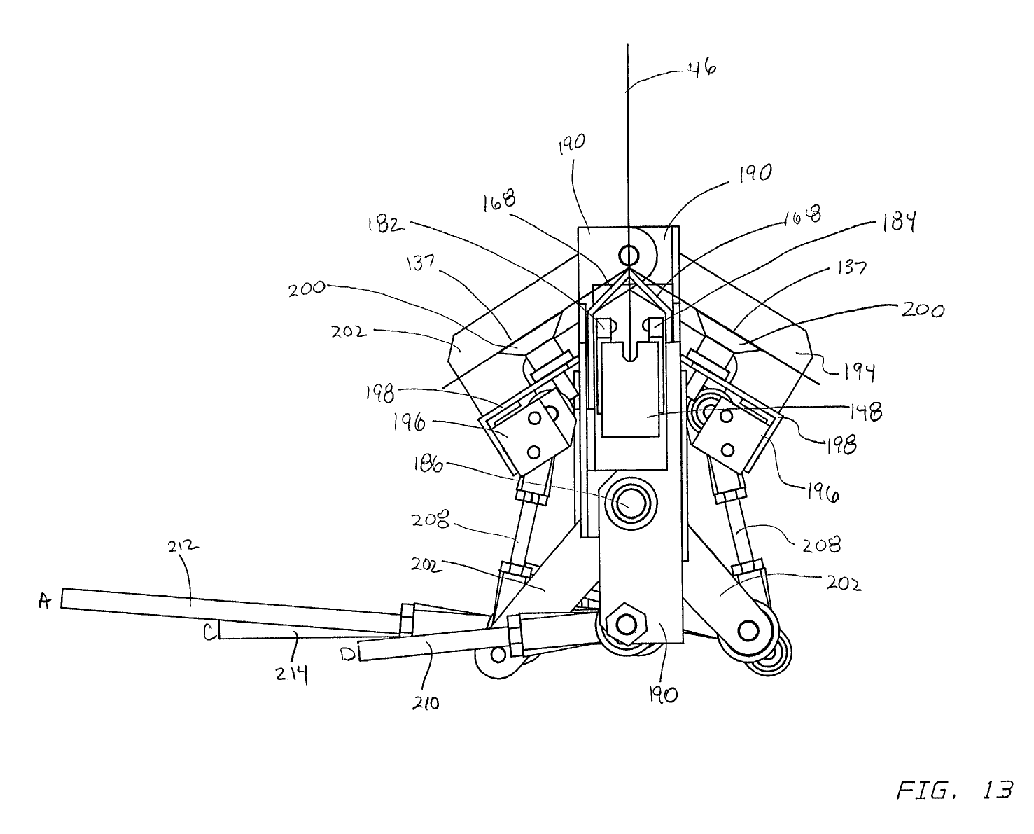

The entire envelope extraction device and its drive assembly are shown in FIGS. 9 and 10 of the drawings but without the envelope transport system as described above. If FIG. 10 is placed to the left of FIG. 12 and the rods A, B, C and D interconnected, the entire assembly and its operating drive mechanism in their relative relationship to one another may be seen. FIGS. 9 and 10 show the envelope extraction device 44 and its drive mechanism in an oblique perspective and in its rest position; i.e., ready to receive an envelope 62 to be opened. FIG. 11 is a side sectional view of the envelope opening/extraction mechanism and drive assembly and should also be referred to in conjunction with FIGS. 9 and 10 for the description of the basic components of the system which follows.

Referring to FIG. 9, the extraction device includes a stationary folder shaft 186. Either end of the stationary folder shaft 186 is secured into vertical uprights which provide the basic support for the entire assembly. Likewise secured into the vertical uprights (not shown) and spaced slightly above the stationary folder shaft 186 is the stationary folder track bar 148. The folder track bar 148 includes a deep recess 188 therein which provides a track within which the unopened edge of the envelope 62 being opened passes in its travel through the apparatus.

The extraction device 44 is symmetrical and the left side portions thereof may be reversed or rotated and used on the right side. The only distinction is that the system is in a mirror image to itself; i.e., the various parts move in directions toward and away from each other, the various actuating mechanisms for the major components thereof will be operating in opposite directions for the left side versus the right side. This will become more apparent from the description of the opening mechanism which follows.

Journaled upon the stationary folder shaft 186 for each complementary part of the mechanism is a pair of folder blade pivot arms 190. Secured to the upper portion of the corresponding pairs of folder blade pivot arms 190 is a folder blade 168. The respective pairs of folder blade pivot arms 190 and associated folder blade 168, as previously stated, are of identical construction and are held in slight offset alignment to one another in the direction of the stationary folder shaft 186 by means of appropriate spacers 192.

At the upper end of each pair of folder blade pivot arms 190 are journaled for pivoting action a like pair of cup bar pivot arms 194. These L-shaped cup bar pivot arms 194 provide the support for a cup bar 196. The cup bar 196 carries laterally adjustable cup clips 198 to which there are secured pneumatic suction cups 200. The suction cups 200 are connected to an appropriate vacuum source through vacuum lines, neither of which is shown.

The stationary folder shaft 186 also provides the journal for an L-shaped cup bar rocker arm 202 for each pair of cup bar pivot arms 194 and associated cup bar 196. Each cup bar rocker arm 202 for its associated assembly of cup bar pivot arms 194 and cup bar 196 are positioned one at each end of the stationary folder shaft 186 and are appropriately positioned with respect to the remaining assembly by means of a spacer 204.

The upper end of the cup bar rocker arm 202 is pivotally interconnected to the lower end of a cup bar connecting link 208. The upper end of the cup bar connecting link 208 is pivotally interconnected to the cup bar 196.

One of the two folder blade pivot arms 190 for each folder blade 168 extends below the stationary folder shaft 186 and provides a pivotal interconnection with a folder blade crank rod 210 associated with the folder blade pivot arm 190 for the right hand folder blade 168. In a like manner but positioned at the opposite end of the stationary folder shaft 186, the folder blade pivot arm 190 extends downwardly below the stationary folder shaft 186 and provides a pivotal interconnection with a second folder blade crank rod 212. The folder blade crank rods 210 and 212 operate in opposite directions during cycling of the opening mechanism. Thus, it will be appreciated that, as the crank rod 210 moves to the right, the folder blade pivot arm 190 will move the folder blade 168 toward the folder track bar 148 and the envelope 62 positioned therein. In a like manner, retraction or movement of the folder blade crank rod 212 toward the left will likewise bring the left hand folder blade 168 to the right toward the envelope 62 and in converging relationship with its opposing folder blade 168. Reverse motion of the folder blade crank rods 210 and 212, of course, opens the folder blades 168 away from one another.

The lower end of each cup bar rocker arm 202 extends below the stationary folder shaft 186. Interconnected to the lower portion of the cup bar rocker arm 202 in a pivotable manner is a cup bar crank rod 214 associated with the left hand cup bar 196 and a second cup bar crank rod 216 associated with the cup bar rocker arm 202 for the right hand cup bar 196. Movement of the cup bar crank rod 214 towards the left will operate through the cup bar rocker arm 202 and cup bar connecting link 208 to pivot the left hand cup bar 196 inwardly toward the envelope 62. In a like manner, movement of the cup bar crank rod 216 towards the right will pivot the right hand cup bar 196 inwardly toward the envelope 62. Accordingly, there is a dual action occurring as the folder blade pivot arms 190 pivot inwardly toward one another, they carry with them the pivot points for the cup bar pivot arms 194 while, at the same time, the cup bar pivot arms 194 are themselves being pivoted upon the folder blade pivot arms 190 by the action of the cup bar rocker arms 202 and cup bar connecting links 208.

The sequential control of the pair of folder blade crank rods 210 and 212 and the cup bar crank rods 214 and 216 and thus their associated folder blades 168 and cup bars 196 is controlled through a drive mechanism as shown in FIG. 10. The drive mechanism includes a pair of shaft supporting walls 218 and 220 and appropriate floor member 222. A drive motor 224 with an appropriate brake and clutch mechanism 226 is secured to the support wall 220 and drives through a drive pulley 228 and a drive belt 230. The drive belt 230 operating through a drive pulley 232 provides the power to a folder blade crank shaft 234.

The folder blade crank shaft 234 carries thereon a folder blade crank shaft gear 236. The folder blade crank shaft gear 236 mates with and drives a cup bar shaft gear 238 of equal number of teeth. The cup bar shaft 240 in turn has disposed thereon and rotating therewith a cam shaft 242 having a cam shaft detent 244. A sensor 246, operably connected to a solid state gating board 248 supported by support 250, is positioned in proximity to the outer circumference of the cam 242 with detent 244 to detect detent 244 and activate gating board 248.

In one embodiment, sensor 246 uses a light emitter and sensor. The light emitter emits a light beam which is not detected by the sensor as the beam is interrupted by cam shaft 242. However, the cam shaft detent 244 allows the light beam to pass, which is detected by the sensor actuating the gating board 248. Alternately, a microswitch could be positioned above the cam shaft 242 which is actuated upon sensing the detent 244.

The folder blade crank shaft 234 has positioned on either end thereof oppositely directed folder blade crank arms 252 and 254. The crank arm 252 is pivotally interconnected through a pivot pin 256 to folder blade crank rod 210, whereas the folder blade crank arm 254 is connected through a like pivot pin 256 to folder blade crank rod 212. Each folder blade crank arm 252 and 254 and their associated pivot pins 256 are slid and bolted upon their respective folder blade crank rods between adjustable collars 258 upon which are positioned dwell springs 260 interposed between the pivot pins 256 and one of the collars 258. The operation of the dwell springs 260 is described hereinafter.

The cup bar shaft 240 has oppositely directed cup bar crank arms 262 and 264 upon its opposite ends. Cup bar crank arm 262 is pivotally interconnected to cup bar crank rod 214. In a like manner, cup bar crank arm 264 is pivotally interconnected to cup bar crank rod 216.

The envelope opening device 14 and its drive assembly, as shown in FIGS. 9, 10 and 11, are positioned ready to receive an envelope 62 to be opened. In the sequence of events, the envelope transfer assembly is operating and an envelope 62 is brought into the opening assembly until the photocell is engaged, whereupon the transfer mechanism is stopped. At that moment, drive motor 224, which is continuously operated, is engaged through clutch 226 to drive the drive belt 230 in the direction of the arrow thereupon with consequent driving of the folder blade crank shaft 234 and cup bar shaft 240 as well as their associated crank arms, all of which, in turn, move their associated crank rods. At this point, folder blade crank rod 212 begins to move to the left as the folder blade crank arm 254, through its associated pivot pin 256, begins to engage dwell spring 260. In a like manner, folder blade crank rod 210 begins to move to the right. As this occurs, the folder blades 168 begin converging together in the opener assembly.

Simultaneously, cup bar crank rod 216, through the associated action of its cup bar crank arm 264, begins to move to the right while cup bar crank rod 214 begins to move to the left. As this action is occurring, the cup bar rocker arms 202 will begin to pivot the cup bars 196 toward one another through the action of cup bar connecting links 208 and toward engagement with the envelope 62.

FIGS. 11, 12, 13 and 14 illustrate four distinct points in the full cycle of 360° of the four crank arms associated with the opener drive mechanism. In each of these FIGS. 11-14, the crank arms and associated crank rods, pivot arms and rocker arms as well as folder blades and cup bars for the left hand portion of the symmetrical assembly are shown in solid lines whereas those associated with the right hand portion of the assembly are shown in phantom lines.

Referring now to FIG. 12, the crank arms have rotated in the direction of the arrow as shown in FIG. 10 to their 90° point. At this point, the folder blades 168 have just come into engagement with the panels of the envelope 62, and the contents 46 therein, to provide a clamping action thereupon. Simultaneously, the folder blade pivot arms 190 carrying the folder blades 168 have moved to their vertical position, wherein the pivot points 206 for the cup bar pivot arms 194 have moved into concentric alignment with one another.

As best shown in FIG. 8, this pivot point 206 is slightly below the upper edge of the folder blades 168 by a distance of approximately ⅛″. Further yet, at the cycle point shown in FIG. 12, the cup bar rocker arms 212, working through the cup bar connecting links 208, have brought the suction cups 200 into engagement with the upper portion of the envelope 62. At this point or slightly before, the control circuitry introduces vacuum to the suction cups 200.

At the 90° crank arm position, as shown in FIG. 12, the folder blade crank arms 252 and 254 will have assumed a 90° position. At this point, the pivot pins 256 will have moved the folder blade crank rods 210 and 212 against the compression of the dwell springs 226 to the point of closing of the folder blades 168 before any appreciable compression of the dwell springs 260.

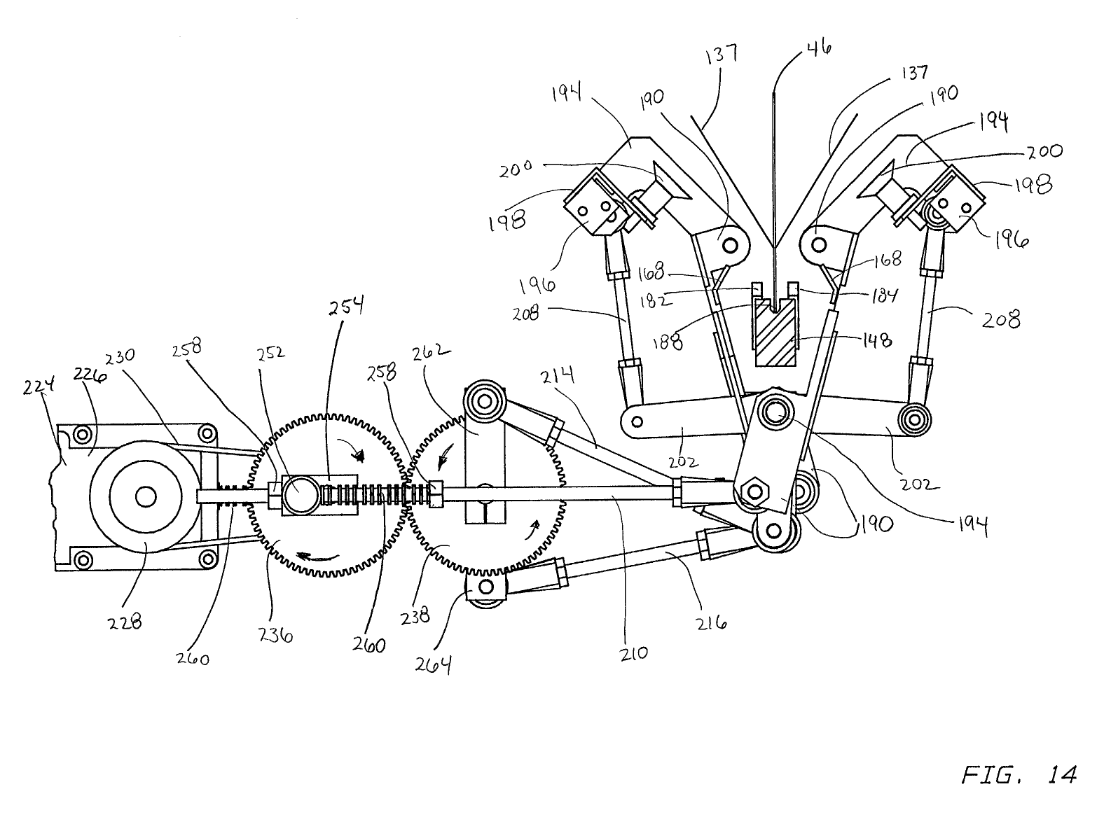

The drive mechanism for the opener shown in FIG. 10 operates on a one continuous complete cycle of 360° at a continuous rotational velocity. Accordingly, the action of the mechanism going from the rest position in FIG. 11 through the positions in FIGS. 12 and 13 and finally arriving back to an opened and rest position shown in FIG. 14 is one continuous action.

As the crank arms continue to rotate from their 90° position shown in FIG. 12, the folder blades 168 continue to maintain their clamping action upon the envelope panels. However, as rotation continues beginning at the 90° point, the opposite actions of cup bar crank rods 214 and 216 will begin to operate through their respective cup bar rocker arms 202 to draw away the cup bars 196 and their associated suction cups 200. As this occurs, the envelope panels gripped by the suction cups 200 will likewise be drawn away with the cup bars 196.

However, at this time, the continued rotation of the folder bar crank arms 252 and 254 have no effect, in that the pivot pins 256 will now begin to compress the dwell springs 260. Compressing the dwell springs 260 does not cause any movement of the folder blades 168 except that, as the increased compression occurs to a maximum point of the 180° point of revolution of the crank arms, pressure on the folder blades 168 will increase. As these cranks begin to move toward their 270° point, the folder blades 168 will continue to be maintained in engagement with the envelope 62 all the way until the 270° point. At the 270° point, compression of the dwell springs 260 will have been substantially dissipated. Thus, the clamping action of the folder blades 168 upon the envelope 62 is constant from a position beginning at approximately 90° of position of the crank arms through and until at least the 270° point.

Referring now to FIG. 13, the interrelationship of the various components of the envelope opener is shown at the 270° cranked position. Again, the folder blades 168 are still in engagement with the panels of the envelope 62. At this 270° point, the cup bar 196 and its associated suction cups 200 have reached their maximum angle of separation. This angle is approximately 240°. At this point, the suction cups 200 have exerted a downward force upon the envelope panels creating a creasing action of the panels at the juncture of the upper edges of the folder blades 168. During this action, due to the large angle upon which the envelope panels are separated, any tendency of the contents 46 within the envelope 62 to stick to the panels is measurable, inasmuch as the contents 46 simply cannot withstand this full downward angle and if they were initially adhering thereto, they would break loose and spring back up into general vertical alignment.

A significant aspect and feature of the milling device 48 of the present invention is the positioning of the pivot point 206 for the cup bar pivot arms 194 with respect to the upper edge of the folder blades 168. As previously indicated, these pivot points 206 associated with each folder bar pivot arm 190 and cup bar pivot arm 194, when in the position from 90° to 270°, are concentric with one another but spaced below the upper edge or data plane of the folder blades 168 by approximately ⅛″.

The effect of such arrangement is that, as the cup bar pivot arms 194 rotate from the 90° cranked position as shown in FIG. 12 to the 270° position as shown in FIG. 13, the pivotal arc of the cup bar pivot arms is not around the upper edge of the folder blades, but below the same and thus is a diverging arc which pulls the panels away from the point at which they are clamped between the folder blades 168. This diverging arc creates tension in the panels thus creating a greater creasing effect of the envelope panels at the clamping point of the folder blades 168.

As the respective crank arms now begin to move from the 270° point back toward the 360° or zero rest point, the compression upon the dwell springs 226 reaches zero and the pivot pins 256 then engage the collars 258 and the folder blades 168 begin to retract away from the envelope panels. Simultaneously, the microswitch cam follower 250 drops into the microswitch cam detent 244 signaling the reaching of the 270° point. At this point, the vacuum to the suction cups 200 is released, and the suction cups 200 are vented to atmospheric pressure, thus releasing their grasp upon the envelope panels. Additionally, a timing function of approximately 200 milliseconds is initiated.

Simultaneously, the crank arms associated with the cup bar crank rods also begin to operate through the cup bar rocker arms 202 and associated cup bar connecting links 208 to return the cup bars 196 to their generally upwardly disposed position as shown in FIG. 11. After the 200 millisecond timeout has occurred, the clutch 226 on the drive motor 224 associated with the drive system is disengaged and a brake is actuated. At this point, the entire opening mechanism has returned to the position shown in FIG. 14 which is identical to the position which the mechanism assumed at the initial beginning point of the opening cycle as shown in FIG. 11 with the exception that the envelope 62, as illustrated in FIG. 14, has now had its panels 137 creased with a permanent deforming crease. At this point, the contents 46 of the envelope 62 are standing essentially vertically and the opposing panels 137 are maintained permanently in an opened position permitting easy access of the contents 46.

Upon timing out of the 200 millisecond timing function and return of the extraction device 44 to that position shown in FIG. 14, the envelope transport system, and particularly the motor operating the folder transfer belt, is energized. As this occurs, the envelope 62 which is grasped within the transport system is moved along the folder track bar out of the extraction device 44.

Referring now to FIG. 15, there is illustrated a cross section of the track trough 38 and envelope track 152 which are positioned below and in between the front edge 32 and back edge 40 of the workstation 12. The track trough 38 and associated envelope track 152 extend throughout the length of the workstation 12 with its right hand portion proximate side edge 24 engaging the exit end of the folder track bar of the opening device 14. The left hand end of the track trough 38 and envelope track 152 extend to just short of the side edge 22. At this point, there is an opening downwardly through the surface (not shown) which is in communication with the empty envelope receptacle 42.

As envelopes 62 sequentially come into the opening device 14, become opened and are discharged therefrom, each successive envelope 62 is pushed against its preceding envelope 62. As this sequence continues to occur, the envelopes 62 move along the envelope track 38 in end to end relationship with their envelope edges creased opened and the contents thereof readily exposed for ease of extraction.

As a further advantage to viewing of the exposed contents 46 of the envelope 62, the envelope track 152 is of a general V-shaped configuration. However, the right hand side of the V, as shown in FIG. 15, is inclined 10° to the right from vertical. This permits the envelopes 62 to be canted toward the front edge 30 to further enhance the view of the contents 46 of the envelope 62. As depicted envelope track 152 includes a separator device 272, which acts to keep envelope panels 137 away from contents 46. In FIG. 15, separator device 272 comprises a pair of bars that hold down the panels 137; however, other items are contemplated, including extended tabs as shown in FIG. 1.

While the above discussed extraction device 44 is preferred, other extraction devices are contemplated, including, but not limited to, an air flow device or a vacuum device among any other suitable extraction device. As provided, an alternate extraction device could comprise an air flow device aligned with at least one edge of the opened envelopes 62. The air flow device produces a flow of air across the envelope 62, spreading the opposed sides of the envelope 62 apart so that the contents 46 thereof are exposed for extraction. This airflow device would work best with an envelope 62 cut only on the longitudinal edge, whereby, when the airflow encounters the envelop 62, the opposed sides would separate forming a pocket.

Alternately, the extraction device could comprise a vacuum device that engages opposing sides of the opened envelopes 62 so that the contents thereof are exposed for extraction. This device would work well with an envelope 62 opened on one, two or three sides.

In one embodiment of apparatus 10 employing vacuum device as extraction device 44, an envelope 62 is conveyed past a extraction head on a vacuum device, with a suction cup mounted in the extraction head. In this embodiment, the suction cup entrains one opposed face of the envelope 62, referred to as the leading face. As the envelope 62 passes horizontally through the extraction device 44, the extraction head rotates so that the leading face entrained by the suction cup is peeled away from the contents 46.

While not depicted, it is contemplated that apparatus 10 could include a number of other devices in operable communication therewith to assist the operator in document processing while maintaining transactional integrity. It is contemplated that opening device 14 could include an envelope preparation device and/or a verification device in operable communication therewith.

While many embodiments are contemplated for the envelope preparation device, a selection of suitable devices includes a jogging device, a sorter or even a metal detector. A jogging device is a device in operable communication with the opening device 14 that imparts a jogging motion to the envelopes 62 prior to opening. This jogging motion assures that the contents 46 are moved away from the at least one edge that is to be opened. A sorting device on the other hand sorts the envelopes 62 based on size prior to opening.

The sorting device assures that only envelopes 62 having a predetermined size are provided to the opening device 14. One example of such a sorting device is a thickness measuring device, which could consist of a pair of opposed pressure rollers. The thickness measuring device determines or measures the thickness of the envelopes 62, so that only envelopes 62 having a predetermined thickness are provided to the opening device 14. Finally, the envelope preparation device could comprise a metal detector to determine if contents 46 include any metal, i.e., staples. Those envelopes 62 containing metal would not be provided to the opening device 14 and would be processed in some other manner.

As discussed previously, apparatus 10 could also include a verification device in operable communication therewith, whereby the opened envelopes 62 are scanned to verify all the contents 46 have been extracted. One example of such a verification device is a candling device operably connected to at least the control device 16.

Candling devices would operatively check the emptied envelopes 62 at various locations in apparatus 10 to make sure that each envelope 62 has been completely emptied, irrespective of its size and the contents 46. The candling devices or series of candling devices preferably operate to periodically check the envelope 62 across its length, as the envelope 62 progresses through the apparatus 10, and to assign a weighted value to the detected reductions in transmitted light, which enables the actual contents 46 to be distinguished from markings or structural features of the envelope 62.

The candling device includes a series of sensors, preferably comprised of a series of photocells, capable of detecting changes in light as the envelopes 62 are passed across. Rather than relying upon ambient illumination of the sensors, it is preferred that the sensors be illuminated by a light source positioned directly over or across from the sensors. Such controlled illumination of the sensors serves to enhance the accuracy of the candling device, as distinguished from ambient illumination which is subject to variation.

Alternatively, a tactile candling device would be employed, in one preferred embodiment located on the envelope track 152 and in operable communication with the control device 16. Such device would tactilly determine the thickness of the envelopes, 62, using pressure rollers or other suitable devices. Any envelopes 62 having a detected thickness greater than a predetermined amount would indicate contents 46 remain therein.

A printer may also be employed, either printer 54 or a stand-alone printer (not shown) preferably in operable communication with the control device 16 by means of an electrical connector. The printer is connected along the path of movement of the envelopes 62 for printing selected information. For example, the printer may be utilized to print batch identification information such as a batch number, a transaction number and a document number on selected documents, checks or remit documents, run times, operator numbers, etc.

While many modes of operation are contemplated, one preferred method of processing the contents 46 of a plurality of envelopes 62 is described below. One skilled in the art will recognize that the preferred method may be modified or deviated from without effecting the process.

The mail room delivers the envelopes 62 to the apparatus 10 and placed in feed tray 56. The operator logs onto the apparatus 10 and opening device 14 using data entry device 43.

As described above, the envelopes 62 may be prepared prior to opening. Preparing the envelopes 62 could include imparting a jogging motion, sorting the envelopes 62 according to size, measuring envelope 62 thickness and detecting any metal.

Once presorting is accomplished, if at all, the envelopes 62 are opened on one, two, three or even all four sides forming opened envelopes, but in one preferred embodiment the envelopes 62 are opened on three sides preferably forming envelope panels 137. Opening device 14 detects the envelopes 62 and opens the envelopes 62 on least one edge, exposing the contents 46 thereof. In a preferred embodiment, the envelopes 62 are opened on at least two sides forming envelope panels 137. A partial crease is formed along a line of a portion of envelopes 62, preferably along at least one of the envelope panels 137, deforming it, preferably by clamping the opened envelopes 62 in a clamping device between which the opened envelopes 62 are disposed, among other extraction methods discussed above.

In a next step, the operator extracts the exposed contents 46 and prepares them for processing. Preparing the contents 46 includes unfolding the documents, reorienting and repositioning the checks and remit documents, etc.

Finally, any new documents from next envelope 62 are prepared for processing. Again, as provided above, as the contents 46 of one envelope 62 are extracted and prepared, the steps are repeated so that a next envelope is opened, and the contents 46 are exposed for extraction.

It will be readily apparent from the foregoing detailed description of the invention and from the illustrations thereof, that numerous variations and modifications may be effected without departing from the true spirit of the novel concepts or principles of this invention.

We claim:

1. An apparatus for exposing the contents of a plurality of envelopes for extraction, comprising:
an opening device for opening the plurality of envelopes on at least one edge by removing a predetermined portion thereof, forming opened envelopes;
an extraction device in operable communication with said opening device for receiving said opened envelopes and exposing the contents thereof for extraction; and
a control device operably connected to at least said opening device and said extraction device, whereby when the contents are extracted from one opened envelope, a next envelope is opened by said opening device.

2. The apparatus of claim 1 wherein said opening device comprises a cutting device forming said opened envelopes.

3. The apparatus of claim 1 wherein said opening device comprises an edge severing device forming said opened envelopes.

4. The apparatus of claim 1 wherein said opening device comprises a milling device forming said opened envelopes.

5. The apparatus of claim 4 wherein said milling device mills the envelopes on at least a leading edge and a longitudinal edge.

6. The apparatus of claim 4 wherein said milling device includes at least one reference device for receiving the envelopes to be opened.

7. The apparatus of claim 6 wherein said milling device further includes at least one mill cutting blade oriented at a predetermined angle to said reference device for removing said predetermined portion and forming said opened envelopes.

8. The apparatus of claim 7 wherein said predetermined portion is between about 0.001 inches and about 0.125 inches.

9. The apparatus of claim 1 wherein said extraction device comprises a deformation device, whereby at least a portion of said opened envelopes are deformed and the contents thereof exposed for extraction.

10. The apparatus of claim 9 wherein said extraction device includes a vacuum device that engages said opened envelopes, whereby the contents are exposed for extraction.

11. The apparatus of claim 9 wherein said extraction device includes an air flow device creating an air draft, whereby the contents are exposed for extraction.

12. The apparatus of claim 9 wherein said deformation device comprises a clamping device between which said opened envelopes are disposed, said clamping device providing at least a partial crease along said portion of said opened envelope so that the contents thereof are exposed for extraction.

13. The apparatus of claim 1 further comprising at least one envelope transport device in operable communication with at least said opening device and said extraction device for serially delivering said opened envelopes so that the contents thereof are exposed for extraction.

14. The apparatus of claim 1 further comprising an envelope receiving device in operable communication with at least said extraction device for serially delivering said opened envelopes so that the contents thereof may be extracted.

15. The apparatus of claim 1 further including a detection device in operable communication with at least said opening device that detects when the contents are extracted from said opened envelopes.

16. The apparatus of claim 1 further comprising an envelope preparation device in operable communication with at least said opening device.

17. The apparatus of claim 1 further comprising a verification device in operable communication with at least said opening device, whereby it is determined that all the contents have been extracted from said opened envelopes.

18. The apparatus of claim 1 further comprising a feeding device in operable communication with at least said opening device, wherein the plurality of envelopes are stored prior to being opened by the opening device.

19. An apparatus for exposing the contents of a plurality of envelopes for extraction, comprising:
a milling device for opening the plurality of envelopes on at least two edges by removing a predetermined portion thereof, forming opened envelopes;
an extraction device in operable communication with said milling device for receiving said opened envelopes and exposing the contents thereof for extraction; and
a control device operably connected to at least said milling device, whereby when the contents are extracted from one opened envelope, a next envelope is opened by said milling device.

20. The apparatus of claim 19 wherein said milling device mills the envelopes on at least a leading edge and a longitudinal edge.

21. The apparatus of claim 19 wherein said milling device includes at least one reference device for receiving the envelopes to be opened.

22. The apparatus of claim 21 wherein said milling device further includes at least one mill cutting blade wheel oriented at a predetermined angle to said reference device for removing said predetermined portion of the plurality of envelopes forming envelope panels.

23. The apparatus of claim 22 wherein said predetermined portion is between about 0.001 inches and about 0.125 inches.

24. The apparatus of claim 22 wherein said extraction device comprises a panel deformation device, whereby at least a portion of said envelope panels are deformed and the contents thereof exposed for extraction.

25. The apparatus of claim 24 wherein said panel deformation device comprises a clamping device between which said opened envelopes are disposed, said clamping device providing a partial crease in at least one of said envelope panels so that the contents thereof are exposed for extraction.

26. The apparatus of claim 25 wherein said clamping device includes opposed elongated folder blades pivoted upon a first common axis between which said opened envelopes are disposed.

27. The apparatus of claim 26 wherein said clamping device further includes opposed elongated grasping members disposed parallel to said folder blades and pivotable upon a second axis and between which said opened envelopes are disposed.

28. The apparatus of claim 27 wherein each said grasping member is pivoted upon a companion folding blade.

29. The apparatus of claim 28 wherein said folder blades each include an envelope panel engagement edge which are aligned with one another when in engagement with said envelope panels.

30. The apparatus of claim 29 wherein said second axis of each said grasping member pivoted upon its companion folding blade are in concentric alignment with one another when said envelope panel engagement edges are in engagement with said envelope panels.

31. The apparatus of claim 30 further wherein said second axes of said grasping member when in concentric alignment are in parallel alignment with said envelope panel engagement edges but not concentric therewith in a direction to provide a diverging arcuate movement of the grasping members pivoting upon their second axes relevant to the axes of said envelope panel engaging means to cause tension upon the envelope blades across the envelope panel engagement edges to enhance creasing thereof.

32. The apparatus of claim 30 further including at least one transport device for selectively conveying the envelopes to be opened into and out of position between said elongated folder blades and said grasping members.

33. The apparatus of claim 32 including at least one transport detection device in operable communication with at least said control device to detect said envelopes between said folder blades, wherein operation of said transport device is discontinued, said folder blades and said grasping members are cycled between an initial release position through engagement with said envelope panels and returned to a release position, and said first transport device is reactivated.

34. The apparatus of claim 33 further comprising an envelope receiving device in operable communication with said transport device for serially delivering said opened envelopes so that the contents thereof maybe extracted.

35. The apparatus of claim 24 further including a detection device in operable communication with said control device that detects when the contents are extracted from said opened envelopes.

36. The apparatus of claim 35 wherein said detection device comprises at least one light source and light detector in operable communication with said control device.

37. The apparatus of claim 24 further comprising an envelope preparation device in operable communication with said milling device.

38. The apparatus of claim 24 further comprising a verification device in operable communication with said milling device, whereby it is determined that all the contents have been extracted from said opened envelopes.

39. The apparatus of claim 38 wherein said verification device includes a candling device operably connected to said control device.

40. The apparatus of claim 24 further comprising a feeding device in operable communication with at least said milling device, wherein the plurality of envelopes are stored prior to being opened by the milling device.

41. The apparatus of claim 24 wherein said control device further includes at least one microprocessor having control logic operational thereon, operably connected to at least said milling device.

42. The apparatus of claim 41 wherein said control logic comprises software, whereby when the contents are extracted from one envelope, said milling device is instructed to mill a next envelope.

43. A method for exposing the contents of a plurality of envelopes for extraction, comprising:
removing a predetermined portion of at least one edge of the envelopes forming opened envelopes;
exposing the contents thereof for extraction; and
controlling said opening and exposing steps using a control device, whereby when the contents are extracted from one envelope and a next envelope is opened.

44. The method of claim 43 including deforming at least a portion of said opened envelopes using a deformation device so that the contents thereof are exposed for extraction.

45. The method of claim 44 further including providing at least a partial crease along a line of said portion of said envelope panels.

46. The method of claim 45 further including clamping said opened envelopes in a clamping device prior to deforming said portion.
